(19) United States
(12) Patent Application Publication
(10) Pub. No.: US 2008/0306842 A1
(43) Pub. Date: Dec. 11, 2008

(54) Transaction Verification System

(76) Inventor: Dawn Battlemann, Zimbali (ZA)

Correspondence Address: MORGAN, LEWIS & BOCKIUS LLP (SF), One Market, Spear Street Tower, Suite 2800, San Francisco, CA, 94105, US

(21) Appl. No.: 11/719,994

(22) PCT Filed: Nov. 23, 2004
(86) PCT No.: PCT/IB2004/003820

§ 371 Date: Nov. 16, 2007

(51) Int. Cl. G06Q 10/00

(52) U.S. Cl. 705/30

(57) ABSTRACT

A transaction verification system comprises a central data processing system and a plurality of satellite data processing systems discreet from the central data processing system. A plurality of audio and/or visual recorders are adapted to record sounds and/or images and to these into digital data which is transferred to the central data processing system by communication means. Each audio and/or visual recorder is associated with one or more satellite data processing systems and the central data processing system includes a data store within which digital data received from the audio and/or visual recorders is stored. The data store being divided into subsidiary data stores, each associated with one or more satellite data processing systems and the central data processing system being programmed to store digital data from audio and/or visual recorders associated with a particular satellite data processing system in a subsidiary data store associated with that satellite data processing system and to communicate data stored in a subsidiary data store only to a satellite data processing system associated with that subsidiary data store.

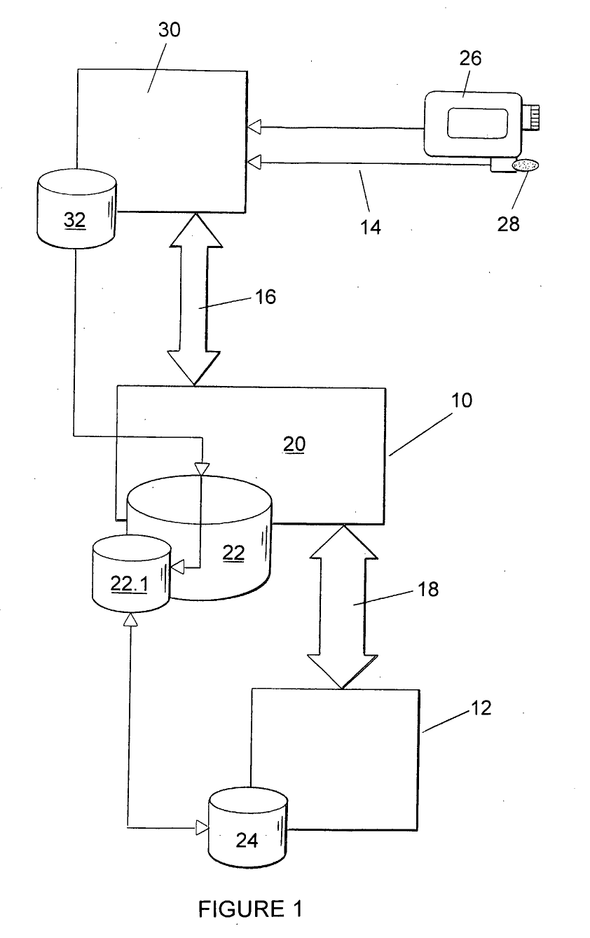

### BACKGROUND OF THE INVENTION

This invention relates to a transaction verification system. All organisations, whether commercial concerns or non-commercial concerns, undertake transactions on a daily basis. These transactions involve routine commercial transactions, such as when sales orders are placed on a commercial organisation by a customer or when the goods or services so ordered are delivered to the customer. Very often, unscrupulous business operators try and avoid their obligations by disputing the validity of such transactions.

This invention seeks to provide a transaction verification system by means of which the occurrence of the transaction and the events forming part of the transaction can be verified.

### SUMMARY OF THE INVENTION

According to the present invention there is provided a transaction verification system comprising a central data processing system, a plurality of satellite data processing systems discreet from the central data processing system, a plurality of audio and/or visual recorders that are discreet from the central data processing system and adapted to record sounds and/or images and to convert recorded sounds and/or images into digital data and communication means by means of which recorded digital data is transferred from the audio and/or visual records to the central data processing system and by means of which the satellite data processing systems communicate with the central data processing system, each audio and/or visual recorder being associated with one or more satellite data processing system, and the central data processing system including a data store within which digital data received from the audio and/or visual recorders is stored, the data store being divided into subsidiary data stores, each associated with one or more satellite data processing system, and the central data processing system being programmed to store digital data from audio and/or visual recorders associated with a particular satellite data processing system in a subsidiary data store associated with that satellite data processing system and to communicate data stored in a subsidiary data store only to a satellite data processing system associated with that subsidiary data store.

The central data processing system may be constituted by an internet service provider and the communication means may be constituted by internet access links.

The satellite data processing systems may be constituted by client's of the internet service provider.

Preferably, the audio and/or visual records are video and sound recording video cameras combined with laptop personal computers.

The present invention extends to a method of verifying a transaction, the method comprising:
receiving audio and/or visual data at a server, the audio and/or visual data including data which verifies a transaction;
storing the audio and/or visual data in a database; and
linking the audio and/or visual data to data detailing the transaction which is to be verified.

The audio and/or visual data may be received at the server via a communications network.

Preferably, the audio and/or visual data which is received at the server is received from a plurality of audio and/or visual data recorders and is stored in the database together with an identification of the audio and/or visual data recorder.

Access to at least some of the stored audio and/or visual data may be given to at least one user who is able to view the data stored in the database.

Preferably, a plurality of users are given access to at least some of the stored audio and/or visual data.

More preferably each user is assigned to one or more audio and/or visual data recorders and wherein each user is only able to access stored audio and/or visual data from a audio and/or visual data recorder to which it is assigned.

### BRIEF DESCRIPTION OF THE DRAWING

The FIGURE is a schematic system diagram of one embodiment of the present invention.

### DESCRIPTION OF EMBODIMENTS OF THE INVENTION

The drawing illustrates an audio and/or visual transaction verification system constituted by a central data processing 10, a plurality of satellite data processing systems 12 (only one of which is illustrated) and a plurality of audio and/or visual recorders 14 (only one of which is illustrated).

The various components of the system are connected to one another by means of communications links constituted by Internet access links denoted by arrows 16,18. Although the links are referred to herein as Internet links, it will be appreciated that the communications between the various components of the present invention could take place over any one of a number of different types of networks and using different communications protocols. For example, the invention could be implemented over a wireless communication network.

In an internet-based system such as this, the central data processing system 10 is constituted by an Internet service provider (10) where a server computer 20 (or a number of servers) operate as a host for the system itself. The server 20 contains a large data store 22, programmed to set up subsidiary data stores 22.1. Each subsidiary data store 22.1 is associated with a particular, satellite data processing system 12.

The subsidiary data processing 12 is constituted by the data processing system of a customer of the Internet service provider (ISP) 10. Such a data processing system may comprise one or more personal computers, whether or not connected in a network and will be referred to herein as the customer system (12).

Using the example of the normal commercial concern, the customer system 12 will typically include an accounting system and supporting system, such as inventory management systems and other enterprise resource planning systems. The transaction verification system of the invention is intended to constitute an adjunct to these systems. As is commonplace, the customer system 12 will normally include a customer data store 24.

In the example illustrated, the audio and/or visual recorder is constituted by a combination of a video camera 26, a microphone 28 and a laptop PC 30. The laptop PC 30 contains a data store 32. The recorder assembly 14 is adapted to convert the images and sounds recorded by means of the video camera 26 and the microphone 28 into digital data that is stored on the hard disk 32 of the PC 30.

The operation of the transaction verification system of the invention can be illustrated with reference to a simple example of a normal, everyday commercial transaction such as the delivery of goods. In such an example, the delivery of the goods and the documentation and data processing steps associated therewith will be undertaken in the normal course in the customer system 12 in addition to simply delivering the goods, however, the delivery person will be required to record the delivery and certain activities pertaining to the delivery by means of the recorder 14.

So, for instance, the delivery person might be instructed, in addition to undertaking the normal activities associated with delivery of goods, such as delivering the goods and having a delivery note signed, to make an audio and/or visual recording of certain aspects of the transaction. For instance, the person making the delivery can, using the video camera and microphone 26, 28 record video clips of the actual delivery of the goods, the signature, by the person taking delivery, of the delivery note and possibly even vocal confirmation of the fact that the person taking delivery is who he or she purports to be, that they have inspected the goods and that the delivery appears to be in order. The video clip or clips together with sound, can then be recorded as digital data on the PC and the hard disk 32 thereof in particular for immediate or later transmission to the ISP 10 by way of the Internet link 16.

The audiovisual recorder 14 is associated, by appropriate identification within the system, with the customer system 12. On making the Internet connection 16, therefore, the operator of the audiovisual system 14 keys in the appropriate identification codes and passwords to allow access to the system and to the data stores 22 of the ISP 10. Within the data stores 22 of the ISP 10, a subsidiary data store 22.1 has been created for the sole use of the customer system 12. When, therefore, the operator of the audiovisual system 14 connects successfully to the ISP 10, the transaction data recorded on the PC 30 will be directed for storage in the subsidiary data store 22.1 associated with the customer system 12.

From time to time the customer operating the customer system 12 will connect to the ISP 10 by way of the Internet link 18, using the appropriate access codes and passwords. It will be appreciated that these access codes and passwords can be differentiated to allow different degrees of access, thereby allowing differentiation within the customer system 12 whereby certain operators in the customer system 12 have access to more or less data contained in the subsidiary data system 22.1, depending on the access privileges concerned.

In connecting successfully to the ISP 10, the customer system 12 will gain access only to the subsidiary data store 22.1 associated with the customer system 12. Once connected, the customer system 12 can be used to download transaction data contained in the subsidiary data system 22.1 to the data stores 24 of the customer system 12.

The data so downloaded will consist of audiovisual clips pertaining to the various transactions recorded during the course of the normal operations of the operator of the audiovisual system 14, in this case, a number of deliveries.

It will be appreciated that the audiovisual transaction verification system of the invention will normally incorporate a large number of audiovisual recorders 14 associated with each customer system 12. In addition, the ISP 10 will host a large number of customer systems 12, each with its own collection of audiovisual recorders 14.

It will also be appreciated that any transactions capable of audiovisual recording can be recorded using the system and that the system is not limited to the examples illustrated above.

The invention has been described above with specific reference to the use of a communication system 16 to download the data to the large data store 22. However, in a less sophisticated environment the audio and/or visual data could be downloaded by returning the audio and/or visual recorder back to a central point where it could be physically docked and thereby connected to the server 20 to download the information thereon.

In addition, although the invention has been described with reference to a plurality of satellite data processing systems 12 and a plurality of audio and/or visual record 14, the present invention could also be implemented for a single data processing system 12 in combination with a single audio and/or visual record 14 or in combination with a plurality of audio and/or visual recorders 14.

This scenario would exist where a single organisation implements the present invention and provides one or more of their delivery personnel, for example, with audio and/or visual recorders 14.

The audio and/or visual data recorded by the record 14 could then be transmitted back to a server of the organisation which could be accessed by employees of the organisation. In this case, there may be one data store which all employees could access or a plurality of data stores for various departments, for example.

It will be appreciated that in this scenario the methodology of transferring the audio and/or visual data back to the server 20 could also vary and could be implemented using connection to a communications networks such as the internet, as has been described above, or another communications network. Alternatively, the audio and/or visual recorders can be docked when they are returned to the organisation and the data downloaded from them at that time.

Thus, in broad terms, the method of verifying the transaction comprises receiving audio and/or visual data at a server, the audio and/or visual data including data which verifies a transaction, storing the audio and/or visual data in a database and linking the audio and/or visual data to data detailing the transaction which is to be verified.

A plurality of users are then assigned to one or more audio and/or visual data recorders and wherein each user is only able to access stored audio and/or visual data from a audio and/or visual data recorder to which it is assigned, typically using access codes and passwords to access the data.

1. A transaction verification system comprising a central data processing system, a plurality of satellite data processing systems discreet from the central data processing system, a plurality of audio and/or visual recorders that are discreet from the central data processing system and adapted to record sounds and/or images and to convert recorded sounds and/or images into digital data and communication means by means of which recorded digital data is transferred from the audio and/or visual records to the central data processing system and by means of which the satellite data processing systems communicate with the central data processing system, each audio and/or visual recorder being associated with one or more satellite data processing system, and the central data processing system including a data store within which digital data received from the audio and/or visual recorders is stored, the data store being divided into subsidiary data stores, each associated with one or more satellite data processing system, and the central data processing being programmed to store digital data from audio and/or visual recorders associated with a particular satellite data processing system in a subsidiary data store associated with that satellite data processing system and to communicate data stored in a subsidiary data store only to a satellite data processing system associated with that subsidiary data store.

2. A transaction according to claim 1 in which the central data processing system is constituted by an internet service provider the communication means being constituted by internet access links.

3. A transaction according to claim 1 in which the satellite data processing systems is constituted by clients of the internet service provider.

4. A transaction according to claim 1 in which the audio and/or visual recorders are video and sound recording video cameras combined with laptop personal computers.

5. A method of verifying a transaction, the method comprising:
receiving, audio and/or visual data at a server, the audio and/or visual data including data which verifies a transaction,
storing the audio and/or visual data in a database; and
linking the audio and/or visual data to data detailing the transaction which is to be verified.

6. A method of verifying a transaction according to claim 5 wherein the audio and/or visual data is received at the server via a communications network.

7. A method of verifying a transaction according to claim 5 wherein the audio and/or visual data which is received at the server is received from a plurality of audio and/or visual data recorders and is stored in the database together with an identification of the audio and/or visual data recorder.

8. A method of verifying a transaction according to claim 5 wherein access to at least some of the stored audio and/or visual data is given to at least one user who is able to view the data stored in the database.

9. A method of verifying a transaction according to claim 8 wherein a plurality of users are given access to at least some of the stored audio and/or visual data.

10. A method of verifying a transaction according to claim 9 wherein each user is assigned to one or more audio and/or visual data recorders and wherein each user is only able to access stored audio and/or visual data from a audio and/or visual data recorder to which it is assigned.
